(19) United States
(12) Patent Application Publication
(10) Pub. No.: US 2005/0198449 A1
(43) Pub. Date: Sep. 8, 2005

(54) Determination of memory configuration

(76) Inventors: Darrell Haskell, Cypress, TX (US); Paul Vu, Tomball, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/794,147

(22) Filed: Mar. 5, 2004

(51) Int. Cl. G06F 19/00; G05B 15/00

(52) U.S. Cl. 711/156; 711/1; 711/170

(57) ABSTRACT

A system is disclosed that comprises a processor, a memory subsystem coupled to the processor, a display coupled to the processor, and logic accessible to the processor that determines the configuration of the memory subsystem and provides a graphical image indicating the memory subsystem's configuration on the display.

### BACKGROUND

Many types of electronic systems can be readily configured by adding or removing components from the system. For example, a computer's memory subsystem can be modified by a user adding memory to, or removing memory from, the computer. It is generally desirable for reliable system operation to correctly configure the system. For example, inserting memory devices in incorrect locations in the system may preclude the system from operating correctly.

### BRIEF SUMMARY

At least some embodiments may include a system that comprises a processor, a memory subsystem coupled to the processor, a display coupled to the processor, and logic accessible to the processor that determines the configuration of the memory subsystem and provides a graphical image indicating the memory subsystem's configuration on the display.

### BRIEF DESCRIPTION OF THE DRAWINGS

For a detailed description of the embodiments of the invention, reference will now be made to the accompanying drawings in which:

FIG. 1 shows a system in accordance with various embodiments of the invention including a memory subsystem;

FIG. 2 shows a memory module; and

FIGS. 3-15 illustrate the operation of a memory configuration manager included in the system of FIG. 1 to identify various examples of a misconfigured memory subsystem.

### NOTATION AND NOMENCLATURE

Certain terms may be used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The term “cartridge” comprises any type of mechanism that can accommodate one or more components (e.g., memory devices) and that can be removed from a system. For example, a cartridge may comprise a removable circuit board to which one or more memory devices may be mated.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

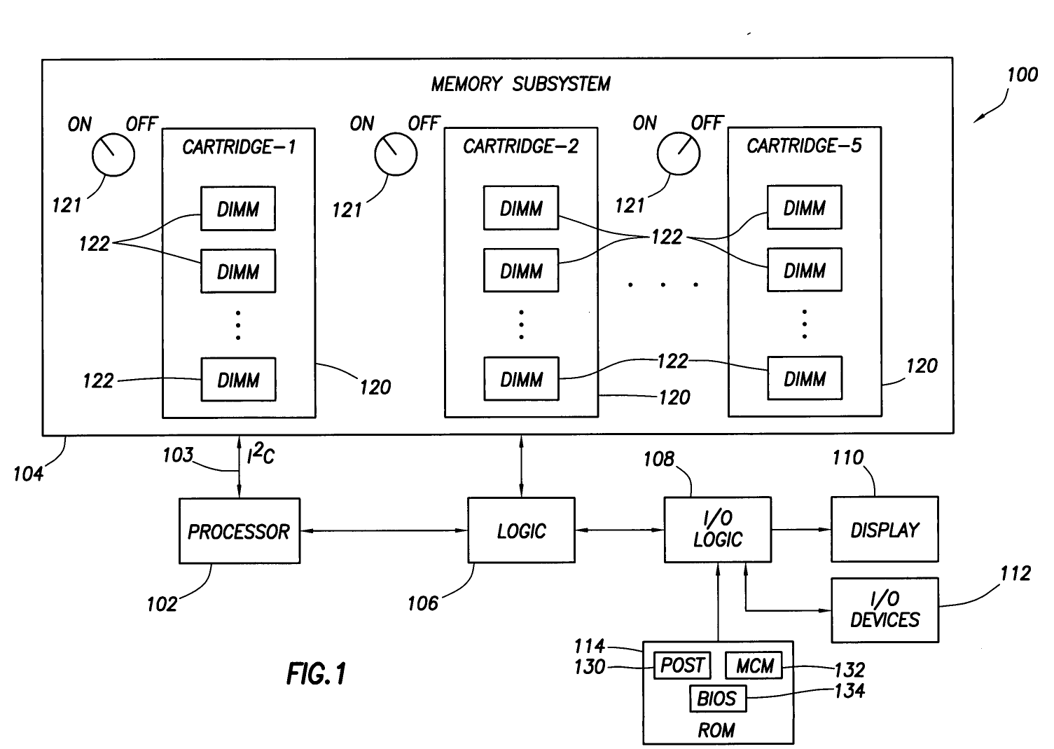

Referring now to FIG. 1, a system 100 may include a processor 102, a memory subsystem 104, logic 106, input/output (“IO”) logic 108, a display 110, one or more IO devices 112, and a read-only memory (“ROM”) 114. The logic 106 may comprise any suitable type of chip set to permit any two or more of the components shown in FIG. 1 to communicate with one another. Logic 106 may include a memory controller, bridge logic, and other functional units as desired. Through the logic 106, the processor 102 may perform read and write transactions to the memory subsystem. Executable code on the ROM 114, such as power on self test (“POST”) 130, memory configuration manager (“MCM”) 132, and a basic input/output system (“BIOS”) 134 may be copied to the memory subsystem 104 through the logic 106 and executed from the memory subsystem by the processor 102. The MCM 132 may be separate from the POST code 130. Alternatively, the functionality of the POST code 130 may be implemented in the POST code 130.

In general, the memory subsystem comprises one or more cartridges 120. Each cartridge may be removable. Further, each cartridge may include one or more memory devices. The term “memory device” as used herein broadly includes any type of device in which data can be stored including, for example, solid state and magnetic memory devices. Further, such memory devices may include memory in any suitable form as in the form of a dual in line memory module (“DIMM”) 122 that comprise one or more memory chips. Each DIMM 122 may be removable from its corresponding cartridge 120. Although the term “DIMM” is used throughout this disclosure, in general, the embodiments disclosed herein pertain to any type of memory unit that can be mated with a replaceable cartridge. Both the cartridge 120 and DIMMs 122 are removable and replaceable thereby permitting a user the ability to remove a cartridge from the system 100, remove, replace, or install new DIMMs 122 on the cartridge 120 and re-install the cartridge back into the system. Further, capacity permitting, a new cartridge 120 may be added to an existing system. In this way, a user may upgrade the memory capacity of the memory subsystem 104 or replace one or more defective DIMMs 122. The reason for changing the DIMMs in the memory subsystem 104 is not significant to this disclosure.

Referring still to FIG. 1, memory subsystem 104 may be implemented as a “hot plug” subsystem. The “hot plug” nature of the memory subsystem 104 permits a cartridge 120 to be removed from, or added to, the memory subsystem while the host system 100 is powered on and otherwise fully operational. To accommodate the hotplug nature of the memory subsystem, a switch 121 is provided for each cartridge 120. Each switch 121 may have an “on” and an “off” position as shown. A user may turn a switch 121 to the “off” position when the associated cartridge 120 is to be removed. Turning the switch 121 to the “off” position alerts the memory subsystem 104 and processor 102 that a hot plug event is about to occur. In response, the system 100 logically isolates the cartridge 120 that is about to be removed from the system to cease any further read or write transactions to that cartridge 120. Once isolated, a user may physically remove the cartridge 120 and, if desired, replace the removed cartridge with a new cartridge. Alternatively, the user may remove the cartridge 120, change one or more of the DIMMs 122 on the removed cartridge 120 and return the cartridge to the memory subsystem 104. Once the cartridge is returned to the memory subsystem, the user then may turn the associated switch 121 to the “on” position to signal the system 100 to begin using the cartridge 120. The system 100 removes the isolation pertaining to the newly installed cartridge to permit memory accesses to be performed to the cartridge.

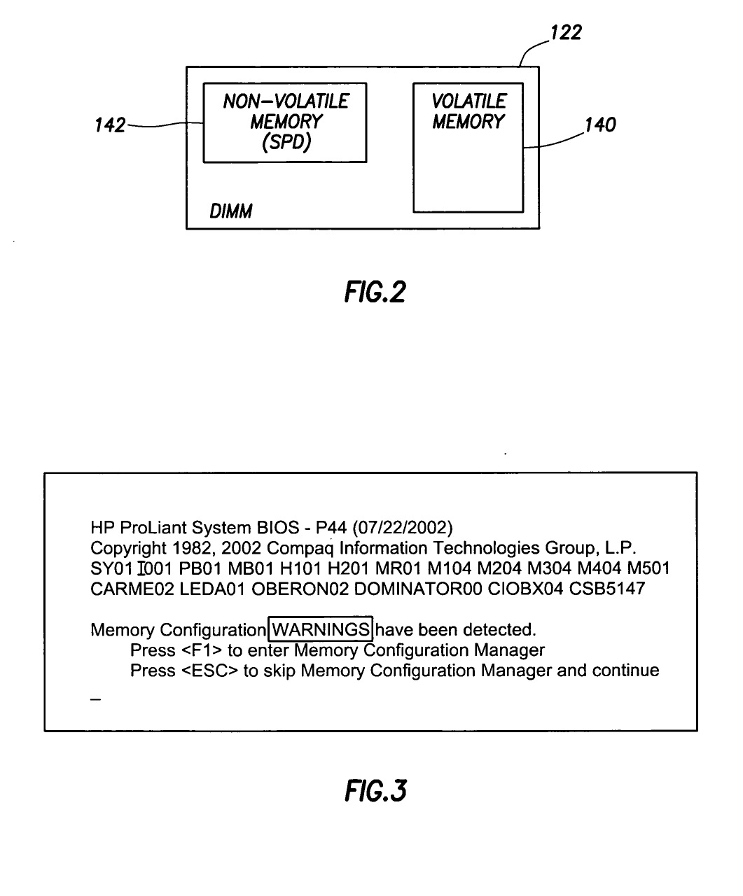

Referring now to FIG. 2, each DIMM 122 may include a volatile memory 140 and a non-volatile memory 142. The volatile memory 140 may comprise any suitable type of random access memory (“RAM”). The non-volatile memory 142 may comprise any suitable type of read only memory or other forms of non-volatile memory. The volatile memory 140 may be used by the system 100 as general scratchpad memory for storing temporary variables and other data as well as for storing executable code for execution by the processor 102. The non-volatile memory 142 may be used for a variety of purposes such as for storing information indicative of the DIMM 122. In accordance with some embodiments, this information may comprise serial presence detect (“SPD”) information. The SPD information generally comprises a plurality of values regarding the DIMM 122 such as the manufacturer, the capacity of the DIMM, the bus speed associated with the DIMM, and the column address strobe (“CAS”) latency. The SPD information stored in each DIMM 122 may be accessed via any suitable mechanism such as via an Inter-Integrated Circuit (,1²C”) bus 103 as shown in FIG. 1 coupling the processor 102 to the memory subsystem 104. The SPD information stored on the various DIMMs may be read during system initialization or during run-time.

Although system 100 has been described as having hot plugable memory, other embodiments of the invention may not include hot plugable memory. In such other embodiments the system is turned off before a memory DIMM is removed or inserted into the system.

Referring again to FIG. 1, the memory configuration manager 132 shown stored on the ROM 114 may be executed by processor 102. The MCM 132 may be copied to the memory subsystem 104 and executed by the processor 102 from the memory subsystem. The ROM 114 also includes POST and BIOS code 130, 134. The POST code 130 includes one or more executable routines that test and configure the system 100 during initialization. The BIOS code 134 includes one or more low-level routines that may be used to interact with various hardware devices such as the I/O devices 112 which may include a mouse, a keyboard, a disk drive, and other suitable devices. Some, or all, of the functionality described below is implemented in the MCM 132 and/or the POST code.

It is possible to physically install multiple DIMMs 122 of various types in a cartridge 120. For example, some DIMMs may have a 128 megabyte (“MB”) capacity while other DIMMs may have a 256 MV or a 512 MB capacity. Further still, some DIMMs 122 may be able to operate on a 100 megahertz (“MHz”) bus while other DIMMs may be able to operate from a 133 MHz bus. The DIMM 122 may vary in other ways as well. As such, the memory subsystem 104 may be configured in a variety of ways. Not only may the memory subsystem 104 include a mix of varying DIMM types, but one or more cartridges 120 may not be fully populated with DIMMs 122 and some cartridges 120 may be missing all together. In general, some configurations are acceptable for proper system operation, while other configurations may not permit the system 100 to function properly. The configurations that permit proper system operation may vary from system to system. Proper system operation generally means that all RAM is installed correctly, is operational, and can be used to boot the system.

In accordance with various embodiments of the invention, logic (e.g., the MCM 132 and/or POST 130) may determine whether the memory subsystem 104 has been configured for proper system operation. If the MCM 132 determines that memory subsystem is not configured for proper system operation, a graphical image is provided to the user on display 110 identifying the present configuration of the memory subsystem with an indication of how the memory subsystem is incorrectly configured. A user then may readily correct the misconfigured memory subsystem and the MCM 132 may verify that the memory subsystem is now correctly configured. The following discussion provides information as to how the MCM 132 may be started as well as various examples of a misconfigured memory subsystem 104 and how the MCM 132 reacts to such misconfigured memory subsystems. In general, the MCM 132 may be executed as long as the memory subsystem 104 is at least configured sufficiently so as to run the MCM 132 and provide at least some text and graphical information on display 110. Thus, although the memory subsystem 104 may not be configured for proper system operation, the MCM 132 may still run as long as the memory subsystem is configured for execution of the MCM 132. Although the MCM 132 is referenced below, some or all of the functionality attributed to the MCM 132 may be applicable to the POST code 130 as well.

The following discussion is based on an embodiment in which the memory subsystem may accommodate up to five memory cartridges 120. Each cartridge may accommodate up to eight DIMMs 122. In other embodiments, more or less than five memory cartridges 120 may be accommodated by the memory subsystem and each cartridge 122 may accommodate more or less than eight DIMMs. Multiple memory cartridges may be provided for redundancy such as that provided by redundant array of independent disk techniques, memory mirroring, and on-line spare technology. Each cartridge 120 may include a socket or other type of connector into which a DIMM 122 may be installed. Each socket may be uniquely identified by, for example, a socket number. In the embodiment in which as many as eight DIMMs may be accommodated by a single cartridge, the socket numbers may range from one to eight (referred to as socket numbers).

The MCM 132 may be started in one of a plurality of ways. For instance, during system initialization, if the POST code 130 determines that sockets 1 and 2 on any of the memory cartridges do not contain matching DIMMs, then the POST code automatically invokes the MCM 132. FIG. 3 shows an exemplary embodiment of information that may be shown on display 110 to indicate that a memory configuration error has been detected (“Memory Configuration WARNINGS have been detected”) and provide a user the option of invoking the MCM 132 (“Press <F1> to enter Memory Configuration Manager”). In other embodiments, the MCM 132 may be invoked if the memory configuration comports with the minimum required configuration, but other configuration or error correction code (“ECC”) errors exist. Further, the MCM 132 may be invoked even if no errors are detected by, for example, a user pressing a predetermined key or key combination on a keyboard.

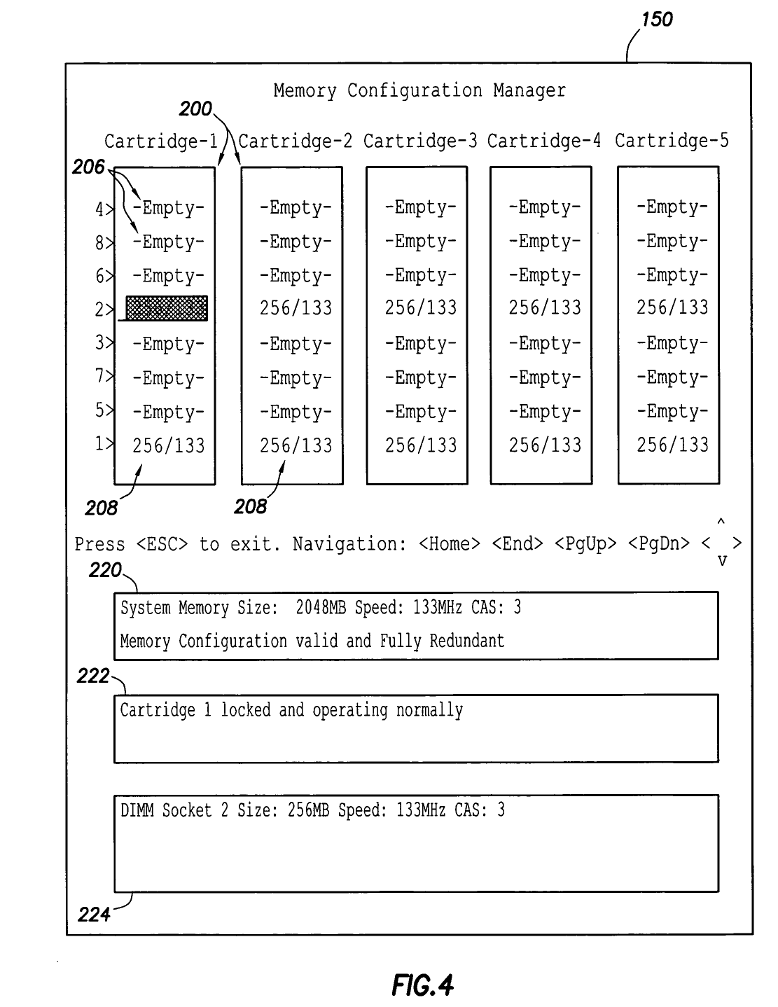

The MCM 132 generally provides a mechanism by which a user can view and, if desired, change the configuration of the memory subsystem 104. The MCM 132 includes a graphical user interface (“GUI”) that shows a graphical image representing the system's current memory configuration. The graphical image may be shown on the system's display 110. An exemplary embodiment of such a graphical image is shown in FIG. 4. As shown, graphical image 150 includes graphical representations 200 corresponding to each of five possible memory cartridges 122, labeled as cartridge-1 through cartridge-5 in FIG. 4. Each cartridge representation 200 includes a graphical representation of the status 206, 208 of each of the eight possible DIMMs 122 that may be installed in the associated cartridge 120. The term “status” in this context may include information about a DIMM location or the operational nature of a DIMM itself. For example, the status may indicate that a particular DIMM location is empty (e.g., status 206) or that a location is occupied by a DIMM as well as information regarding such DIMM (e.g., status 208). Such DIMM status information may include any one or more parameters such as the storage capacity (e.g., 256 megabytes) of the DIMM and the bus speed (e.g., 133 MHz) associated with the DIMM. As shown in the example of FIG. 4, the graphical image 150 indicates that five cartridges 120 are installed in the system and sockets 1 and 2 of all five cartridges are occupied by the same type of DIMM (i.e., 256 megabyte capacity and 133 MHz bus speed).

Referring still to the example of FIG. 4, the graphical image 150 also includes three status boxes 220, 222, and 224 which provide additional information. Status box 220 includes textual information regarding the system's memory subsystem and thus may be referred to as the “memory subsystem information box.” In the example of FIG. 4, such memory subsystem information may include, referring to status box 220, the total amount of memory available for use in the subsystem (e.g., 2048 MB), the operational speed of the memory subsystem (e.g., 133 MHz) and the column address strobe (“CAS”) latency (e.g., 3). Status box 222 includes textual information regarding at least one of the cartridges 120 such as a cartridge that the user may have highlighted by using a mouse to move a cursor over one of the cartridges. Status box 222 may be referred to as the “cartridge information box.” The cartridge information box 222 in FIG. 4 indicates that cartridge-1 is locked in place and operating normally. Status box 224 provides the current status of at least one of the DIMMS 122 associated with the selected cartridge and is referred to as the “DIMM information box.” The DIMM whose information is provided in box 224 may be the DIMM highlighted by a user moving the cursor over the desired DIMM using, for example, the left, right, up, and down arrow keys on the keyboard. In the example of FIG. 4, the DIMM in socket number 2 (shown shaded in FIG. 4) has a 256 megabyte capacity, a bus speed of 133 MHz, and a CAS latency of 3. The user is free to navigate from one memory cartridge graphical representation 200 to another and from one DIMM representation 206 to another. Information regarding the selected cartridges 200 and DIMMs 206 is updated in information boxes 222 and 224 as new cartridges and/or DIMMs are highlighted.

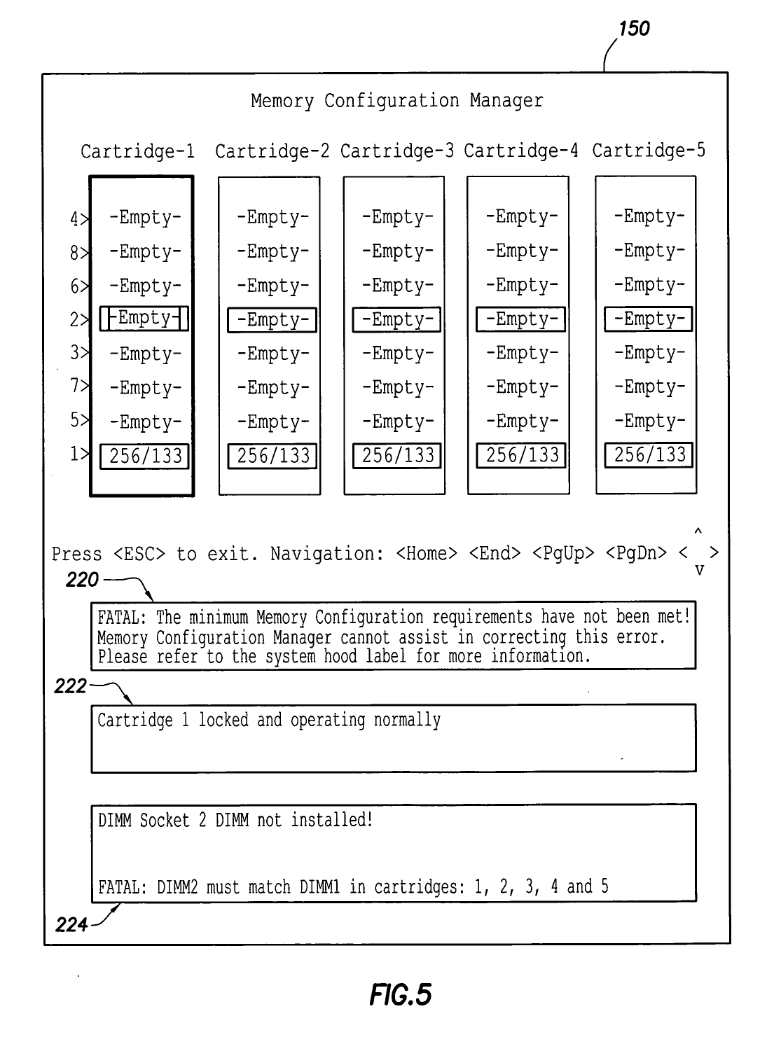

FIG. 5 includes a graphical representation of the memory subsystem's configuration when the DIMMs are not configured for full system operation. The delineation between a memory subsystem configuration that comports with full system operation and configurations that do not comport with full system operation naturally may vary from system to system. For the system depicted in FIG. 5, full system operation may require that, at a minimum, sockets 1 and 2 on each cartridge 120 are populated with DIMMs 122 and such DIMMs are of the same type (e.g., the same capacity, bus speed, CAS latency). In FIG. 4, DIMMs are installed in both sockets 1 and 2 of each cartridge 120 and all such DlMMs are of the same type. Accordingly, the memory subsystem configuration depicted in FIG. 4 represents a configuration that permits full system operation.

In FIG. 5, DIMMs are not installed in socket number 2 of each cartridge 120. Accordingly, memory subsystem information box 220 indicates that the minimum memory configuration for full system operation is not met. The DIMM information box 224 provides additional detail regarding the configuration error. In FIG. 5, cartridge-1 is highlighted by a user and thus DIMM information box 224 indicates a reason for the configuration error is that socket number 2 does not contain a DIMM. The DIMM information box 224 also provides textual information to remind the user that the DIMMs installed in sockets 1 and 2 must match as explained above. If the user has not highlighted a DIMM, boxes 220, 222 and 224 may be blank (i.e., contain no information). Alternatively, a predetermined DIMM for a predetermined cartridge (e.g., DIMM 1 of cartridge-1 may be automatically selected for purposes of the information that is shown in boxes 220-226.

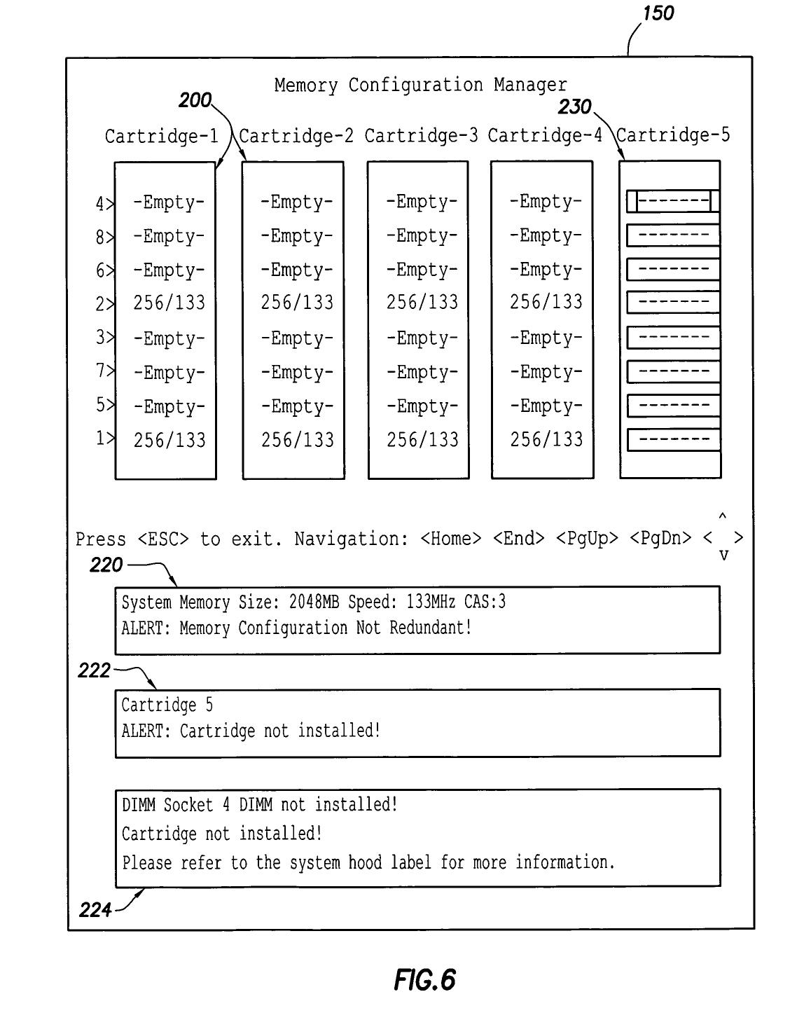

FIG. 6 shows a graphical representation of a memory subsystem configuration in which one of the five memory cartridges 120 is not installed. In the example of FIG. 6, the missing cartridge 120 is cartridge-5. Cartridge-5 may be required for redundancy and thus, without cartridge-5 the memory subsystem lacks redundancy. The missing cartridge-5 is shown graphically by a graphical depiction 230 that differs from the depictions 200 associated with cartridges 120 that are installed in the system. The difference in graphical depiction may be color-based, highlights, the use of flashing graphics, or other visual techniques as may be desired. Further, memory subsystem information box 220 provides textual information to alert the user that the memory subsystem 104 has not been configured to provide redundancy. The cartridge information box 222 alerts the user that cartridge-5 is not installed.

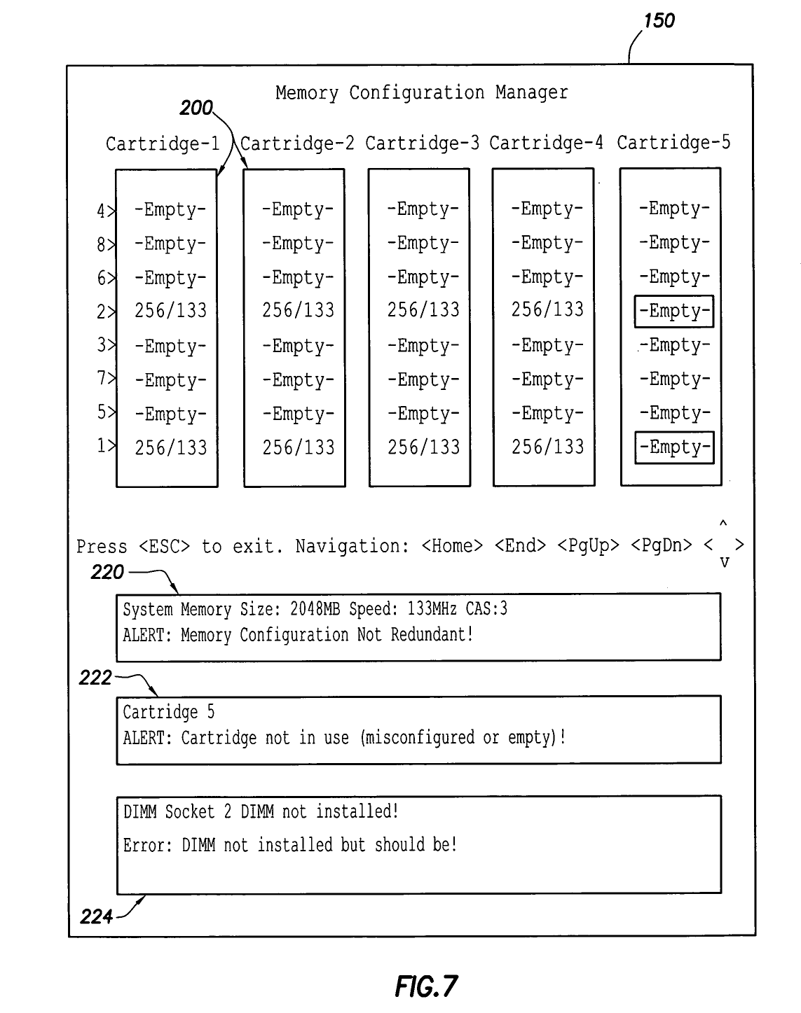

FIG. 7 shows a graphical representation 150 of a memory subsystem configuration in which, unlike that of FIG. 6, cartridge-5 is present, but is not populated with DIMMs in socket numbers 1 and 2. The MCM 132 visually emphasizes the empty socket locations in cartridge-5 and provides appropriate text in status boxes 220-224 as shown.

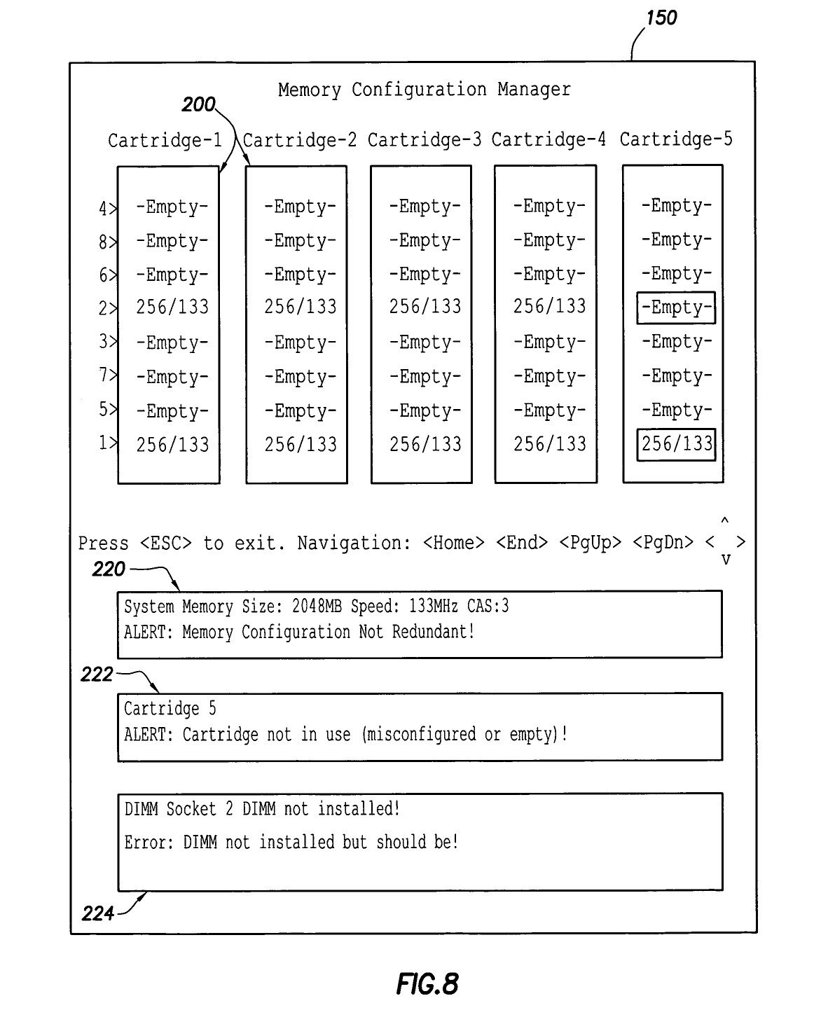

In FIG. 8, cartridge-5 is installed and does have a DIMM in socket number 1. However, socket number 2 of cartridge-5 does not contain a DIMM and thus full system operation may not be permitted. Status boxes 220-224 may provide appropriate textual information to alert the user as to the configuration problem.

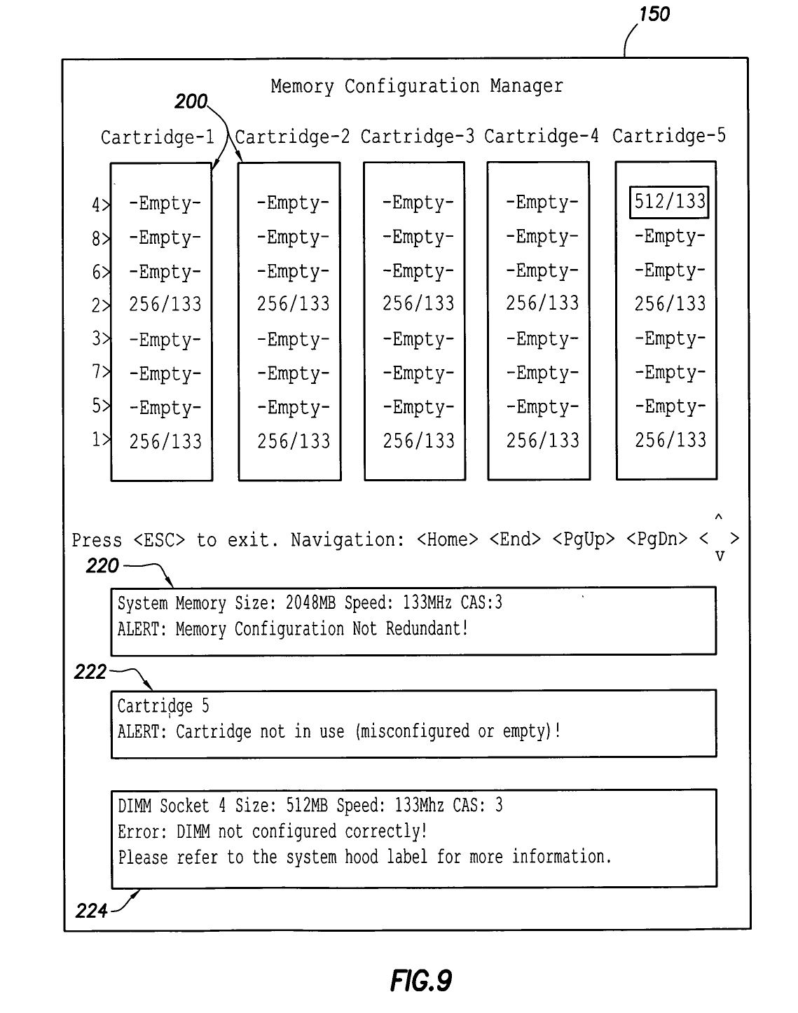

In FIG. 9, all five cartridges include the same type of DIMMs in both sockets 1 and 2. In the system depicted in the example of FIG. 9, however, cartridge-5 is still misconfigured because DIMMs should be installed in pairs on the cartridge which is not the case for the memory subsystem configuration depicted. Such pairs include sockets 1 and 2, sockets 3 and 4, sockets 5 and 6, and sockets 7 and 8. As such, if a DIMM is installed in socket 4 in cartridge-5, as is the case in FIG. 9, the same type of DIMM should be installed in socket 3. In the example of FIG. 9, cartridge-5's socket 3 is empty and thus cartridge-5 is not configured correctly. Further, even if cartridge-5's socket 3 was populated by a DIMM of the same type as that in cartridge-5's socket 4, the memory subsystem 104 still not would not be configured correctly in that sockets 3 and 4 of the remaining four cartridges (cartridge-1 through cartridge-4) do not contain DIMMs of the same type as that in the corresponding locations in cartridge-5. Moreover, in the embodiments described herein, DIMMs in sockets 3 and 4 are not required, but if the user installs a DIMM in socket 4 of one cartridge, the same type of DIMM should be installed in socket 3 of the same cartridge as well as in sockets 3 and 4 of the remaining cartridges. The MCM 132 provides textual information in status boxes 220-224 pertaining to this configuration issue.

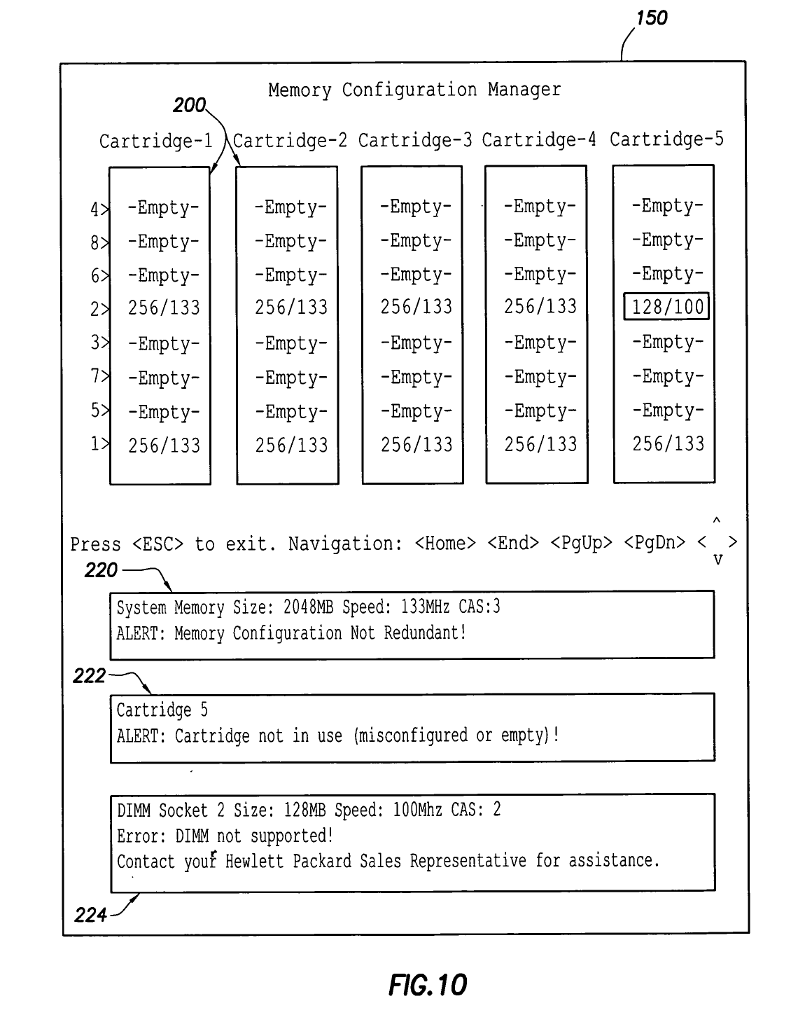

FIG. 10 illustrates a memory subsystem misconfiguration in which each of cartridge-1 through cartridge-4 has the same type of DIMMs (256 MB, 133 MHz) in sockets 1 and 2, and cartridge 5 has the correct DIMM type in socket 1, but not socket 2. Instead, socket 2 includes a 128 MB, 100 MHz DIMM. The MCM 132 provides appropriate textual information in status boxes 220-224 indicative of this situation.

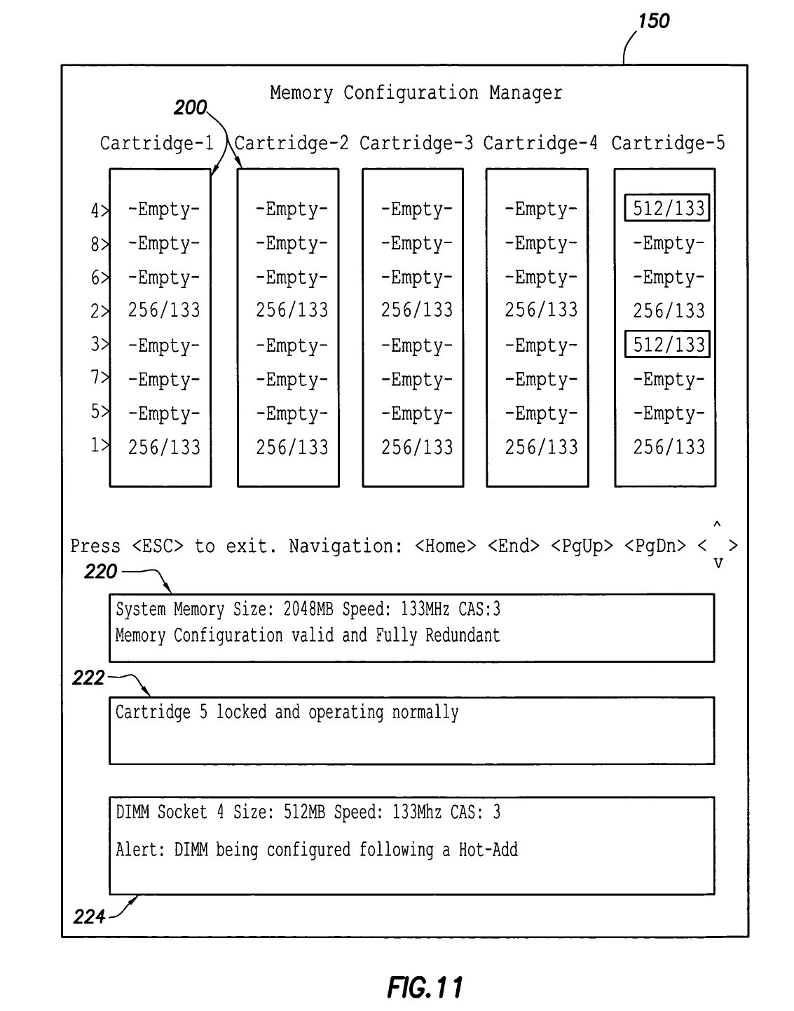

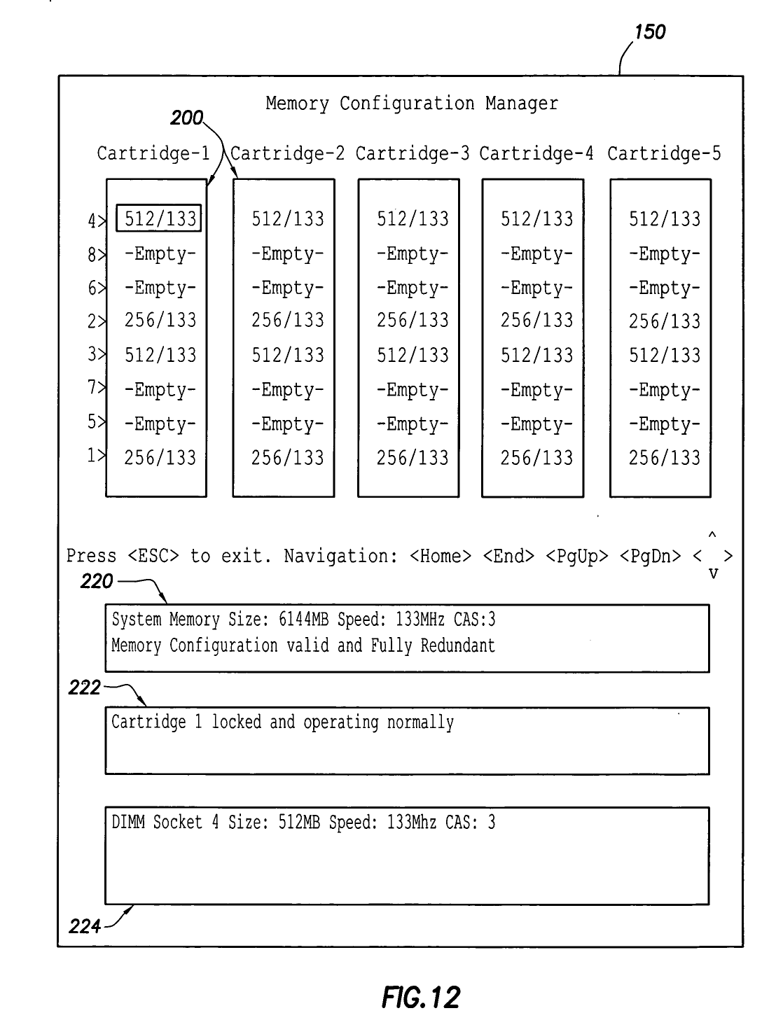

As explained above, the DIMMs 122 may be hot pluggable. Further, if the MCM 132 provides a graphical representation on the display 110 to alert the user that the memory subsystem is misconfigured, the user has an opportunity to correct the configuration by removing and/or installing DIMMs/cartridges in a suitable manner. Alternatively, rather than correcting a misconfiguration problem, the user may desire to add additional DIMMs. For example, in FIG. 11, the user has added 512 MB DIMMs in sockets 3 and 4 in cartridge-5. The addition of DIMMs in cartridge-5, sockets 3 and 4, causes the MCM 132 to update its graphical representation to reflect the newly added DIMMs. Alternatively, the MCM 132 may be invoked upon the system 100 detecting the presence of the newly added DIMMs. The MCM 132 may provide textual information in the DIMM information box 224 to indicate that one or more DIMMs have been added. Once matching 512 MB DIMMs are added to sockets 3 and 4 of the other cartridges (cartridge-1 through cartridge-4) in accordance with the requirements of the particular system 100, the MCM 132 may update the graphical representation to that shown in FIG. 12 which indicates graphically and textually that the memory subsystem is accurately configured.

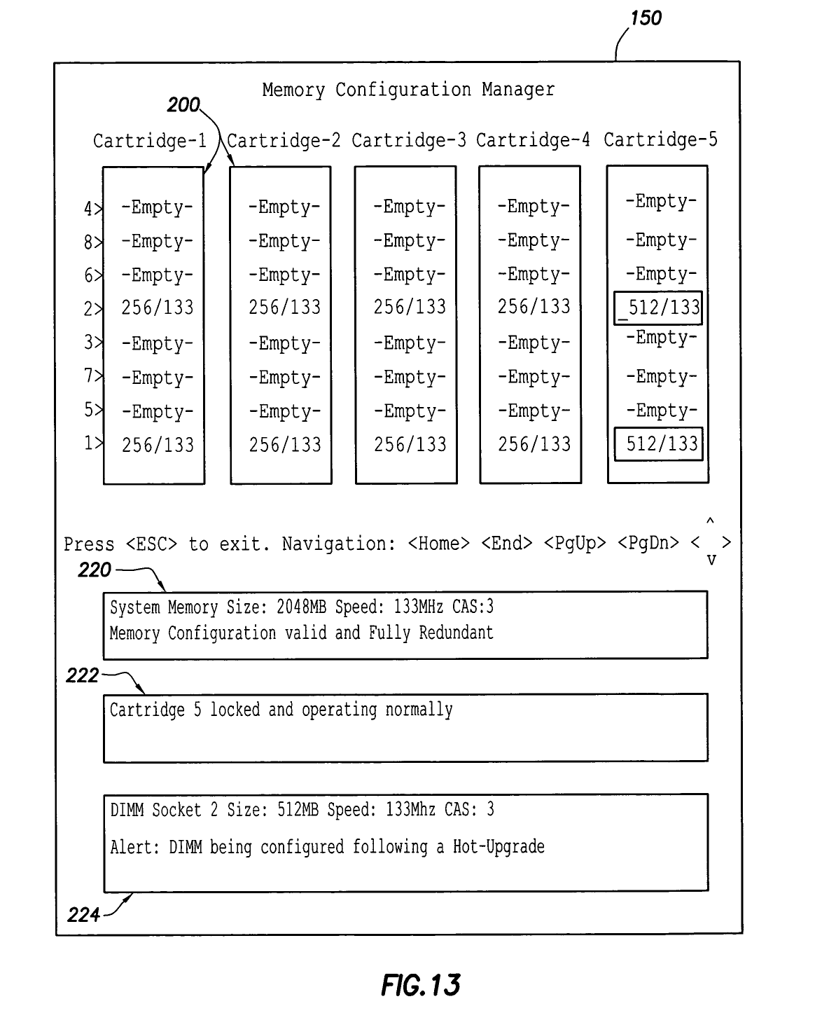

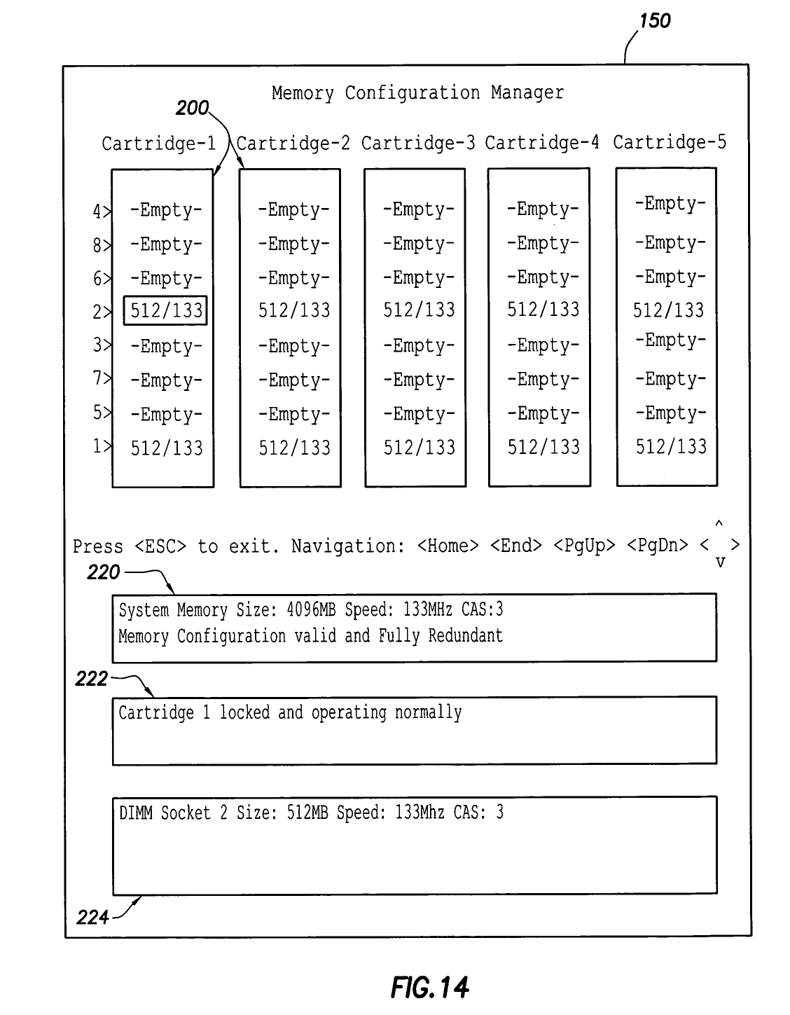

FIG. 13 illustrates the operation of the MCM 132 when a user replaces an existing DIMM with a DIMM having a different capacity. In the example of FIG. 13, the user is upgrading the previously installed 256 MB DIMMs with 512 MB DIMMs. FIG. 13 depicts the response of the MCM 132 after only the 256 MB DIMMs in cartridge-S are replaced with 512 MB DIMMs. FIG. 14 depicts the graphical representation provided by the MCM 132 on display 110 after the user has upgraded all of the DIMMs in sockets 1 and 2 of the five cartridges.

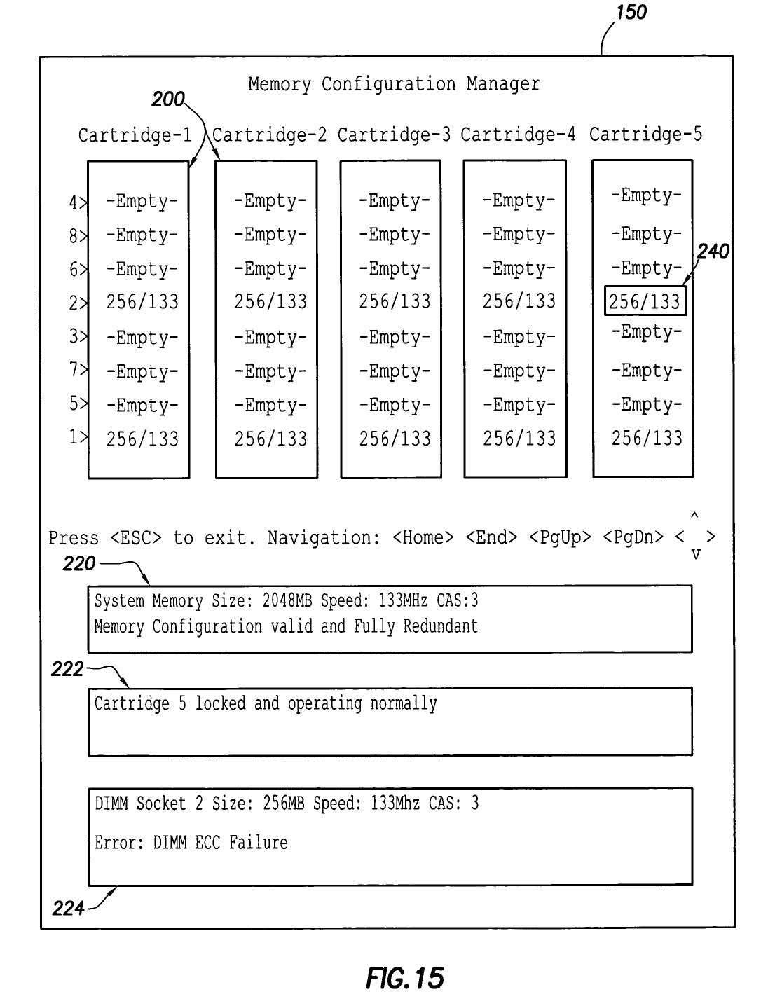

While properly configured, one or more DIMMs may experience an ECC failure indicating that more than a predetermined number of ECC errors have been experienced by a DIMM in a predetermined unit of time. FIG. 15 illustrates this situation with a graphical representation of the memory subsystem that provides ECC failure information in DIMM status box 224. The failure depicted in FIG. 1 is associated with the DIMM in socket number 2 of cartridge-5 and thus is highlighted as shown at 240.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A computer system, comprising:
a processor;
a memory subsystem coupled to said processor;
a display coupled to the processor; and
logic accessible to the processor that determines the configuration of the memory subsystem and provides a graphical image indicating the memory subsystem's configuration on the display.

2. The computer system of claim 1 wherein, if said memory subsystem is not configured correctly, said logic provides information on the graphical image that indicates how the memory subsystem is not configured correctly.

3. The computer system of claim 1 wherein said memory subsystem comprises a plurality of cartridges, each cartridge configured to accommodate a plurality of memory devices, and the graphical image includes a representation of each cartridge and the memory devices contained in each cartridge.

4. The computer system of claim 3 wherein the representation of each cartridge and the memory devices includes textual information regarding each memory module.

5. The computer system of claim 4 wherein said textual information includes one or more items of information selected from the group consisting of capacity and bus speed.

6. The computer system of claim 1 wherein said logic comprises executable code.

7. The computer system of claim 1 wherein said memory subsystem comprises a plurality of hot pluggable memory devices and said logic automatically updates said graphical image as a memory device is removed from or added to the memory subsystem.

8. The computer system of claim 1 wherein the memory subsystem can accommodate one or more memory cartridges, each cartridge adapted to receive one or more memory devices, and the graphical image indicates the presence or absence of each of the one more memory cartridges.

9. The computer system of claim 1 wherein the memory subsystem comprises at least one cartridge that can accommodate one or more memory devices and the graphical image indicates the presence or absence of each of the one or more memory devices.

10. The computer system of claim 1 wherein the memory subsystem can be configured for redundant operation and the graphical image indicates whether the memory subsystem is configured for redundant operation.

11. The computer system of claim 1 wherein the memory subsystem is configurable to include a plurality of cartridges, each cartridge contains sockets for a plurality of memory devices and the graphical image indicates status information for each socket or memory device contained in a socket.

12. The computer system of claim 11 wherein the status information indicates whether different types of memory devices are installed in said cartridges.

13. A storage medium on which code is stored, said code being executable by a processor and, when executed by the processor, causes the processor to:
determine a configuration of a plurality of memory modules;
determine whether the configuration satisfies full system operation; and
show a graphical representation of the configuration on a display.

14. The storage medium of claim 13 said code further causing the processor to show the graphical representation if the configuration does not satisfy full system operation.

15. The storage medium of claim 13 wherein said memory modules can be removed and inserted while the system is operational and said code further causes the processor to determine whether the configuration satisfies full system operation and to show an updated graphical representation when a memory module is removed from or inserted into the system.

16. The storage medium of claim 13 wherein said code is executed if the memory modules are configured to permit the code to be executed and the graphical representation to be shown on the display.

17. The storage medium of claim 13 wherein the code further causes the processor to show the graphical representation as indicating the presence or absence of each of the plurality of memory modules.

18. The storage medium of claim 13 wherein the memory modules can be configured for redundant operation and the code further causes the processor to show the graphical image as indicating whether the memory modules are configured for redundant operation.

19. The storage medium of claim 13 wherein the code further causes the processor to show the graphical representation as indicating memory type associated with each module.

20. A method usable in conjunction with a memory subsystem having a plurality of locations in which memory devices may be installed, the method comprising:
initiating a request for information from each of the memory device locations;
if no information is returned from a particular location, determining that no memory device is present in that location;
determining a configuration of the memory subsystem based on any information returned from any memory devices present in the subsystem and based on the determination as to which locations do not have a memory device; and
displaying an image of the configuration.

21. The method of claim 20 wherein the information comprises serial presence detect information stored in non-volatile storage in the memory devices and specifies one or more parameters selected from the group of parameters consisting of memory capacity and bus speed.

22. The method of claim 20 further including determining whether memory devices are inserted in correct locations.

23. The method of claim 22 further including displaying textual data associated with one or more memory devices not being inserted in correct locations.

24. The method of claim 20 further including determining whether a memory device is missing and displaying graphical and textual information indicative of a missing device.

25. A system, comprising:
a processor;
a memory subsystem coupled to said processor and adapted to accommodate a plurality of memory modules;
a display coupled to the processor; and
a means for determining whether the memory modules are installed in the memory subsystem so as to enable full system operation and for graphically displaying an image indicative of the memory modules installed in said memory subsystem.

26. The system of claim 25 wherein said means includes a means for displaying textual information regarding the memory subsystem if the memory modules are not installed so as to enable full system operation, said textual information indicating how the memory modules are not installed to enable full system operation.

27. The system of claim 25 wherein said means includes means for updating said image each time a memory module is removed from or installed in the memory subsystem.
